(19) United States
(12) Patent Application Publication
(10) Pub. No.: US 2011/0262615 A1
(43) Pub. Date: Oct. 27, 2011

(54) Apparatus for the Production of a Sparkling Beverage

(75) Inventor: Fabrizio Tarricone, Muro Lucano (Potenza) (IT)

(73) Assignee: Drive Beer s.r.l., Balvano (IT)

(21) Appl. No.: 13/132,200

(22) PCT Filed: Nov. 2, 2009
(86) PCT No.: PCT/IT2009/000493

§ 371 Date: Jul. 14, 2011

(30) Foreign Application Priority Data
Dec. 2, 2008 (IT) MI2008A 002134

(51) Int. Cl. B01F 3/04; A23L 2/54; C12C 12/00; A23L 2/00

(52) U.S. Cl. 426/592; 99/275; 426/477

(57) ABSTRACT

The present invention relates to an apparatus (1, 21) for the production of a sparkling beverage comprising a container (2) for containing the sparkling beverage having inlet and outlet openings (9, 13) respectively, detection means (3) of the level or of the weight of the sparkling beverage contained in the container (2), a displacement pump (4) located upstream of the container (2) for feeding a given liquid ingredient or mixture of liquid ingredients therein, means apt to permit the inflation of at least one given food-grade gas or mixture of food-grade gases in the container (2), at least one suction duct (7) in communication with the displacement pump (4), a delivery duct (8) extending between the displacement pump and the container (2), and injection means (6) for the injection of the liquid ingredient or of the mixture of liquid ingredients in the container (2).

### FIELD OF APPLICATION

The present invention relates, in its more general aspect, to an apparatus for the production of a sparkling beverage.

More particularly, the invention relates to an apparatus for the production of a beverage with the addition of at least one food-grade gas, preferably carbon dioxide, small in size, which allows to obtain an end product of high homogeneity and having the required liquid/gas ratio, particularly suitable for use in bars, pizzerias, restaurants and also in the home.

### PRIOR ART

The success on the market of sparkling beverages, which are increasingly popular with consumers, is known.

This success has encouraged the spread and consumption, in addition to beverages packaged already with gas, for example in drums, cans or bottles, also of beverages to which gas is added at the time of consumption, for example in a bar.

The beverages packaged with gas in drums or bottles suffer from the drawback associated to the container itself wherein the beverage is packaged which often, in particular in the case of drums, has an economic value even higher than the beverage which it contains and is therefore subject to all the disadvantages associated to its recovery or to its reimbursement.

Moreover drums, like bottles have a considerable environmental impact mainly due to their overall dimensions and to their weight, with consequent high costs of transport and storage.

The beverages to which gas is added at the time of consumption are instead generally obtained by adding carbon dioxide to a still liquid, that is to say free from gas, or by adding carbon dioxide to dilution water of the same beverage if the latter is obtained, for example, from a syrup or concentrate.

In particular, the carbon dioxide is added in continuous in a duct wherein the still liquid or dilution water flows, obtaining a beverage whose gasification is not optimal and precise in terms of liquid/gas ratio since it is obtained on a reduced amount of liquid, that is to say the amount tapped for a serving or in any case for a limited number of servings.

In a limited time range, such as that which serves for performing the above operation of tapping, and for limited amounts of ingredients, the dosing pumps are highly inaccurate.

The prior art has also made available further solutions such as that described, for example, in the patent application US 2005/0129807 which describes a method for obtaining an alcoholic beverage containing carbon dioxide, more particularly a beer.

This solution, like other methods and apparatuses common on the market, have however been found to be somewhat complex in structural and functional terms in addition to being relatively costly to manage.

### SUMMARY OF THE INVENTION

An object of the present invention is to provide an apparatus for the production of a sparkling beverage having such structural and functional features as to overcome the drawbacks mentioned with reference to the prior art, that is to say an apparatus considerably simplified in the number and in the functionality of its components, small in size, with simplified management and above all able to ensure a precise dosage of the component ingredients of the beverage, therefore an optimal liquid/gas ratio, in addition to an optimal mixing of the same ingredients and a constant availability thereof.

The abovementioned object is achieved, in accordance with the present invention, by an apparatus for producing a sparkling beverage as defined in claim 1 herein.

Alternative embodiments of the apparatus according to the invention are defined in claims 2 to 15.

The invention also provides a process for producing a sparkling beverage as defined in claim 16 herein.

Alternative embodiments of the process according to the invention are defined in claims 17 to 22.

Further features and the advantages of the invention shall become clearer from the detailed description of an apparatus according to the invention, made hereafter with reference to the attached drawings, provided only for illustrative and non-limiting purposes.

### BRIEF DESCRIPTION OF THE DRAWINGS

In the drawings:

FIG. 1 represents schematically an apparatus for producing a sparkling beverage according to the present invention;

FIG. 2 represents schematically a variant embodiment of the apparatus of FIG. 1, wherein the sparkling beverage is obtained from two different liquid ingredients;

FIG. 3 represents schematically an enlarged detail of the apparatus of FIGS. 1 and 2, in accordance with a further embodiment of the invention.

### DETAILED DESCRIPTION

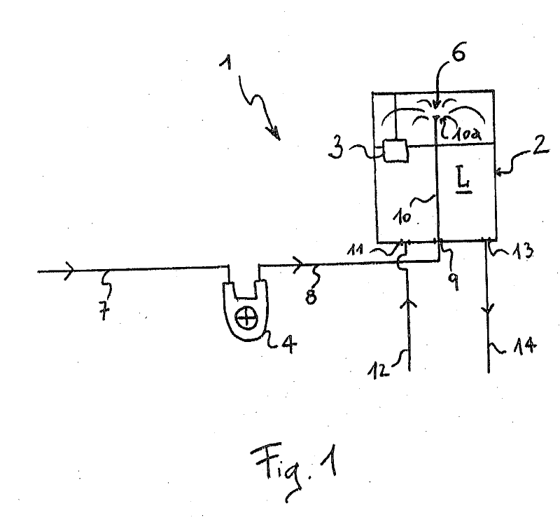

With reference to FIG. 1, an apparatus for producing a sparkling beverage is indicated in its entirety by 1.

The apparatus 1 comprises basically a container 2 for containing and for the tapping of the sparkling beverage provided with inlet and outlet openings respectively, detection means 3 of the level or of the weight of the sparkling beverage contained in the container 2, a displacement pump 4 located upstream of the container 2 for feeding a given liquid ingredient or mixture of liquid ingredients therein, means apt to permit the inflation of at least one given food-grade gas or a mixture of food-grade gases in the container 2 and injection means 6 for the injection, preferably in a rain-like or spray fashion, of the abovementioned liquid ingredient or mixture of liquid ingredients in the container 2.

In detail, the container 2, which is cylindrical, comprises a base, a side wall and a removable closure cover, secured to the side wall by dedicated attachment means so as to withstand a preset pressure value or a pressure value comprised within a preset range of values, preferably a value between 0.5 and 10 bar, which is produced inside the same container, as shall become clearer herein below.

Alternatively, the abovementioned container can also be provided as one-piece, that is to say without removable cover but in any case a closed container apt to withstand a preset value of internal pressure.

The apparatus 1 further comprises connection ducts for feeding via the abovementioned displacement pump 4 the abovementioned liquid ingredient or mixture of liquid ingredients in the container 2.

In particular, in accordance with a first embodiment of the invention schematised in the example of FIG. 1, the apparatus 1 comprises a suction duct 7 having a first end connected to an inlet opening of the displacement pump 4 and a second end intended for connection to a source or supply of the abovementioned liquid ingredient or mixture of liquid ingredients, and a delivery duct 8 extending between, and connected to, an outlet of the displacement pump 4 and an inlet opening 9 provided at the base of the container 2.

Inside the container 2, the apparatus 1 comprises a channel or canal 10, substantially rigid and vertical, for example a metal tube of limited section, in communication with the delivery duct 8, which extends from the abovementioned inlet opening 9 for a length slightly smaller than the height of the container 2, apt for a substantially rain-like or spray fashion feeding of the liquid ingredient or of the mixture of liquid ingredients in the same container 2.

For this purpose an appropriate valve, nozzle or a similar sprayer/diffuser device is preferably housed or formed near a free end 10a of the channel 10.

As regards the abovementioned detection means 3 of the level or of the weight of the sparkling beverage contained in the container 2, it should be added that, advantageously, they can consist of a device internal to the container, such as a float, a suspension device, a balance, a probe or an internal sensor, as shown in the example of FIG. 1, or can consist of a device external to the container 2, such as for example a weight-detecting device such as a balance, or a probe or an external sensor, this possibility not being illustrated in the drawings.

In any case these detection means 3 are apt to trigger the operation of the abovementioned displacement pump 4 in order to maintain, internally to the container 2, an amount of liquid, therefore of sparkling beverage, constant in volume or in weight, or better still an amount of liquid comprised within a preset range of values of volume or of weight.

For example a range of values of volume comprised between two and four litres in the case of a container with capacity of five litres.

The abovementioned means apt to allow the inflation, internally to the container 2, of a given food-grade gas or mixture of gases, are given by an inlet opening, indicated with 11, provided on the base of the container 2, which advantageously allows the food-grade gas to bubble from the bottom upwards in the liquid head (L) contained in the container 2, as shall become clearer from the following.

In detail, by means of this inlet opening 11, the container 2 is placed in unidirectional fluid communication with at least one source of gas, for example a cylinder of carbon dioxide not shown in the drawings.

Other gases which can be used in the present invention in addition to the aforementioned carbon dioxide comprise food-grade gases commonly used in the prior art, for example nitrogen, nitrogen protoxide, argon and their mixtures.

For this purpose an inflation duct 12 connects the abovementioned inlet opening 11 and the at least one source of gas, advantageously provided with a pressure reducer for maintaining, internally to the container 2, a preset value or range of values of pressure.

It should be added that the abovementioned means apt to allow the inflation of gas internally to the container 2 can comprise, in accordance with some embodiments of the present invention, also more than one inlet opening for gas and relative inflation ducts, in particular in the case wherein feeding is required in the container of single food-grade gases rather than a single gas or a mixture of food-grade gases, that is to say gases already mixed.

Moreover the inlet opening or openings for the gas can also be provided on the side wall of the container 2 and/or on the closure cover of the container.

Furthermore the abovementioned means apt to allow the inflation of gas internally to the container 2 can be given by an inlet opening for gas provided in the abovementioned delivery duct 8 extending between the displacement pump 4 and the container 2, in which in practice the inflation duct 12 engages, this possibility not being illustrated in the drawings.

In this case the gas or the mixture of gases encounters the liquid ingredient or the mixture of liquid ingredients in a point upstream of the container 2 in which it arrives partly already solubilised in the liquid ingredient or in the mixture of ingredients, and partly by dragging, transported by the flow of the same liquid ingredient pushed by the displacement pump.

For this purpose the abovementioned injection means, for example a sprayer/diffuser device such as a valve, a nozzle and similar devices, may directly engage the abovementioned inlet opening for the injection, preferably substantially in a rain-like fashion, of the liquid ingredient or of the mixture of liquid ingredients in the container 2, or be associated with, or formed in, a duct or canal extending inside the container 2 for a preset limited length, starting from this inlet opening provided in the upper end portion of the container 2.

What is described above is true both in the case of injection of the liquid ingredient or of the mixture of liquid ingredients and the injection of the gas or of the mixture of gases in the container 2 taking place via various openings and in the case of the liquid ingredient and the gas coming together upstream of the container as considered above.

What is preferable is that at least the injection of the liquid or at least of the mixture of liquids takes place substantially at an upper end of the container 2, basically in a rain-like or spray fashion, irrespective of the direction of provenance of the same liquid ingredient or of the mixture of ingredients, with wetting of the side wall of the container 2, as shall be clearer from the following.

Therefore, in accordance with what is described above and according to a further embodiment of the present invention, the container 2 may also comprise a plurality of inlet openings for the injection of the liquid ingredient or of the mixture of liquid ingredients and possibly of the gas or of the mixture of gases, distributed for example circularly on the side wall or in the cover of the container 2, advantageously provided with respective injection means.

With regard to the abovementioned displacement pump, it should be added that it comprises a single chamber divided into sections, for example four sections defined by respective stators or blades, and it preferably operates at a pressure higher than 1 bar, the possibility of operating at values of pressure higher than 10 bar, or even higher than 20 bar, however, not being ruled out.

The amount of liquid ingredient set in motion by the displacement pump, that is to say the amount aspirated, is in relation to the amount drawn from the container 2 via the abovementioned outlet aperture, indicated with 13, advantageously equipped with a drawing device, for example a tapping device indicated with 14.

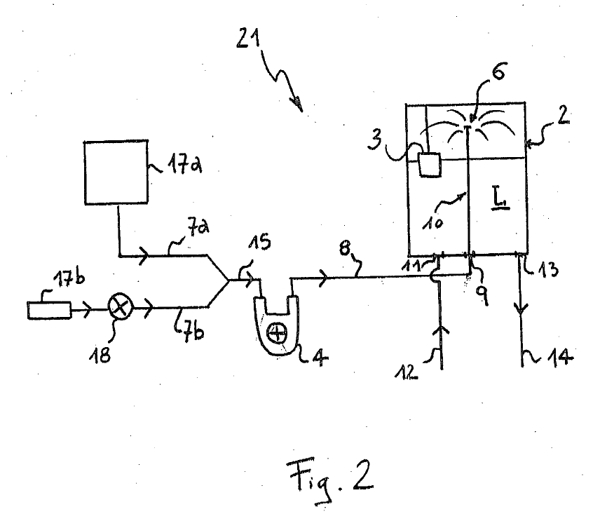

To produce a sparkling beverage from two or more liquid ingredients, or even from two or more mixtures of liquid ingredients, for example a concentrate, a syrup, and water, the present invention makes available an apparatus 21, which is described herein below with particular reference to the example in FIG. 2, wherein the parts structurally and functionally identical to those of the apparatus 1 retain the same reference numerals.

The apparatus 21, wholly similar to the apparatus 1 also as regards the variant embodiments described previously, is also characterised by having at least two suction ducts, intended for connection to respective sources or supplies of the liquid ingredients which form the sparkling beverage.

Source or supply refers to any container containing the liquid ingredient, whose nature depends on the type of ingredient contained and may consist, for example, of a carton, a bag in box, a tank and similar containers, or it may consist of direct access to a distribution line, for example a dispensing tap of a drinking water system.

In particular, in the example of FIG. 2, the apparatus 21 comprises a first and a second suction duct, indicated with 7a and 7b, respectively for the suction or drawing of a first liquid ingredient, for example a concentrate such as beer with high alcohol content, contained in a box denoted by 17a, and of a second liquid ingredient, for example water, directly from a dispensing tap 17b of a drinking water distribution system.

In this case an electrovalve or a pressure reducer 18 is advantageously placed between the dispensing tap 17b and the displacement pump 4, positioned and active on the abovementioned second suction duct 7b.

It should be pointed out that, similarly to what is illustrated here, an electrovalve or a pressure reducer can advantageously be also provided in the apparatus as described with reference to FIG. 1 and relative variant embodiments.

In accordance with the invention, the abovementioned first and the abovementioned second suction duct 7a, 7b, converge, upstream of the displacement pump 4, in a collecting pipe indicated with 15, which is engaged in an inlet opening of the same displacement pump 4.

In practice, as shown in the example of FIG. 2, the first and the second liquid ingredients arrive at the displacement pump 4 via the same collecting pipe 15, the possibility, however, not being ruled out of providing in the same displacement pump two inlet openings, one opening for each of the first and second suction ducts.

In accordance with the invention, the abovementioned first and second suction ducts 7a, 7b, are given advantageously by flexible capillary tubes each having a preset length/section ratio, determined by the relative amount of the liquid ingredients in the sparkling beverage and, for example, by the specific weight of the liquid ingredient intended to be transported, or by other typical parameters or features of the ingredient, or again on the basis of the pressure whereto the same liquid ingredient is subject at the relative source or supply.

Therefore the first and the second suction duct can be provided with different lengths and/or sections.

For example, for a beverage having a ratio equal to five parts of diluent and one part of concentrate, it is possible to have, the cross-sections being equal, a first capillary tube having a first preset length for the diluent to be drawn in five parts, and a second capillary tube having a second preset length, five times greater than the first length, for the concentrate.

Advantageously, this allows a single pump to aspirate simultaneously, in a single and same time span, the two liquid ingredients in the desired relative amounts, that is to say with a precise and optimal ratio of first liquid ingredient amount/second liquid ingredient amount in order to obtain, from the mixing of these two liquid ingredients, the desired sparkling beverage.

Alternatively, the amount of the first and the amount of the second liquid ingredient, therefore their relative dosage, can be controlled and managed electronically, for example by means of at least one electronic card or PLC provided to complete the present apparatus and not illustrated in the drawings.

In this case appropriate valve or jaw means will for example be provided, also not illustrated in the drawings, to act on the abovementioned suction ducts for the timed closure and opening thereof on occasion of the dosage of the liquid ingredients.

It should be pointed out that what is described above with reference to the electronic control may also be provided in relation to the apparatus 1 and the relative variant embodiments described previously.

As considered previously, the suction of the displacement pump is triggered by the abovementioned detection means 3 when the head of sparkling beverage (L) in the container 2 reaches a certain value or lower level, for example following the tapping of a certain amount of the same beverage.

The displacement pump remains active for a length of time necessary for the reinstatement, in the container 2 maintained under pressure, of a preset head of liquid, that is to say of a preset upper level, while the gas or the mixture of gases is inflated in the container and therefore in the liquid itself.

In particular, in accordance with what was considered previously, it should be pointed out that the gas or the mixture of gases can be inflated in the container 2 to maintain inside thereof a preset value of pressure, or a value of pressure comprised within a preset range of values.

Therefore, the inflation of gas may be provided at each tapping of the sparkling beverage, irrespective of the injection of other liquid in the container 2, or be provided jointly with the injection of liquid in the container in order to re-establish therein a preset liquid head and a preset value of pressure.

Naturally the higher this preset value of pressure, or the value of the upper limit of the abovementioned range, the more sparkling is the end beverage, advantageously without having undergone any undesirable contact with oxygen.

It should also be noted that, advantageously, the first and the second liquid ingredient are mixed starting from the displacement pump, or even in the abovementioned collecting pipe, substantially at low pressure.

The mixing of the liquid ingredients upstream of the container 2 allows to perform a gasification under pressure already on a mixture of ingredients, obtaining a beverage of high quality.

Moreover the liquid and gaseous ingredients continue mixing also in the container, inside of which there is a certain pressure value.

In particular, the mixture of liquid ingredients is enriched with the desired amount of gas, both because the head of liquid is held under atmosphere of this gas and because the mixture of liquid ingredients injected preferably in a rain-like fashion in the container facilitates the contact with this atmosphere gas, and possibly also thanks to the bubbling of the gas in the liquid head, as considered previously.

The result is a sparkling beverage with high homogeneity of the liquid phase and with a desired liquid/gas ratio, also in the case of different liquid ingredients, therefore also a desired and optimal ratio in weight or volume between the different liquid ingredients.

Advantageously, the sparkling beverage is constantly available in the container 2 since it is reintegrated therein whenever a preset low level is reached.

From the container 2 the sparkling beverage can be tapped for a serving, possibly with prior or subsequent refrigeration, heating or in any case sent to a system for any other treatment, in any case exploiting the pressure of the gasification gas.

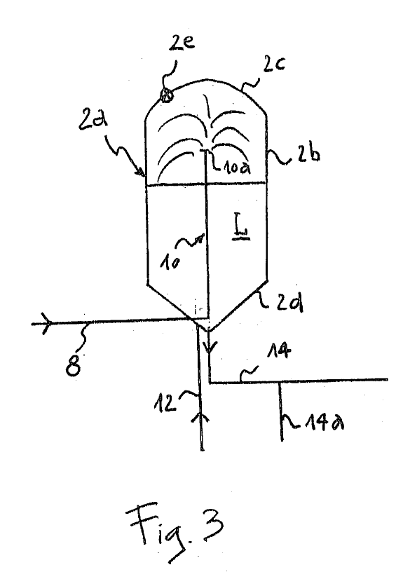

As regards again the abovementioned container, it should be added that, in accordance with a preferred embodiment of the present invention, the container can be provided with a so-called cylindro-conical shape as shown with particular reference to the example of FIG. 3, wherein this container is indicated with 2a.

In particular, the container 2a is a closed container preferably made in one-piece and comprises an upper cylindrical portion 2b with round or substantially domed head wall 2c and a truncated cone lower portion 2d, in detail an overturned trunk of cone.

The upper portion is equipped with a safety valve 2e, which actuates in the case wherein the pressure inside the container reaches a preset critical threshold.

The container 2a is made substantially devoid of sharp internal corners and advantageously allows, thanks also to the abovementioned cylindro-conical shape, prevention of undesirable phenomena of depositing or stagnation of the sparkling beverage, in addition to allowing a simple washing and an effective sanitisation automatically of the same container, as shall be clearer from the following.

In the example of FIG. 3, similarly to what was considered previously, are also shown the head of liquid (L), the canal 10 having a free end 10a for the injection in a basically rain-like or spray fashion of the liquid ingredient or ingredients, the delivery duct 8 whose relative opening is not shown, the inflation duct 12 whose relative opening is not shown, and the tapping device 14, which advantageously comprises a deviation provided with a discharge tap 14a.

Naturally what is described with reference to the inlet and outlet openings of the container in the apparatuses 1 and 21 and relative variant embodiments illustrated previously is to be considered to hold true also for the container 2a, just as a discharge tap or safety valve can be provided also in the embodiments illustrated and described in the abovementioned FIGS. 1 and 2.

It should also be pointed out that the components of the present apparatus, where required, are electrically connected in a known manner and therefore not shown.

In accordance with what is described above, the present invention also makes available a process for producing a sparkling beverage.

In particular a process is disclosed for producing a sparkling beverage from at least two liquid ingredients which comprises the steps of:

drawing from the abovementioned respective sources given relative amounts of at least a first and a second liquid ingredient;
mixing, in continuous, in a common chamber, the first and the second liquid ingredient, thus continuously obtaining the above-mentioned mixture of liquid ingredients;
conveying, in continuous, the abovementioned mixture of liquid ingredients in the abovementioned closed container at a pressure comprised between 0.5 and 10 bar, this pressure being exerted by the abovementioned at least one food-grade gas or by a mixture of food-grade gases inflated in the container, thus obtaining a preset liquid head of sparkling beverage.

Advantageously the abovementioned steps are repeated any time the liquid head in the container reaches a preset lower value.

The abovementioned mixture is preferably injected in a substantially rain-like or spray fashion in the container under pressure.

The abovementioned rain-like or spray injection preferably determines, internally to the container, the wetting of the surface portion of the container external to the liquid head.

The abovementioned relative preset amounts are preferably drawn in a same time span.

The abovementioned relative preset amounts are preferably aspirated by means of the abovementioned displacement pump which advantageously also constitutes the abovementioned common chamber for mixing in continuous the liquid ingredients.

This process has found to be particularly advantageous for producing a carbonated beer comprising carbon dioxide, obtained from a concentrate of beer and water respectively, and can naturally be used to produce a sparkling beverage from a higher number of liquid ingredients as previously considered also with reference to the apparatus described previously.

In this respect, it should be added that the operation of the present apparatus and also the relative advantages, already clear during the present description, can be summarised by noting that the present invention makes available an apparatus for the production of a sparkling beverage, of limited overall dimension, simplified in the number and in the functionality of the components, which at the same time is particularly precise in terms of dosage of the ingredients, producing with precision a preset liquid/gas ratio, also in the case of use or more than one liquid ingredient, for example a concentrate and a diluent liquid.

In particular, the gasification of the beverage takes place in the container under pressure, involving a considerable amount of liquid and not limited as occurs in known processes.

Moreover, advantageously, in the case of a beverage obtained from several liquid ingredients, gasification is performed directly on the mixture of the liquid ingredients which are already mixed upstream of the container, and more particularly by and in the displacement pump.

The amount of liquid ingredient or of mixture of liquid ingredients, injected in the container to reintegrate of the beverage tapped, is controlled by detection means, for example the abovementioned balance or the abovementioned float, in such a way that in the container there is always an amount of sparkling beverage comprised within a preset range of values.

In this way the mixing also involves considerable amounts of liquid ingredients with the result of high homogeneity and of a considerable precision of the amounts mixed.

In fact the different liquid ingredients are drawn by means of a single displacement pump, substantially not pressurised or at low pressure, and dosed by means of the abovementioned preset length/section ratio of the suction capillary tubes, or by means of electronic control, with high control of the relative amounts.

The advantages of the present invention appear even clearer in case the abovementioned sparkling beverage consists of a beverage obtained from a respective concentrate, for example beer with a high alcohol content, diluted with mains drinking water and with added carbon dioxide, all this without significant contact taking place with oxygen which, as is known, is the cause of undesirable alterations in the organoleptic properties or other characteristic properties of the beverages.

In this case, in fact, in the abovementioned pressurised container a beverage is obtained which is highly homogeneous in the liquid phase, ready to be tapped or conveyed to a tapping system, and which retains the features of the beer packaged in drums, notoriously considered the best.

In practice, although obtained from a concentrate, the sparkling beverage is reconstituted and stored in the pressurised container in the absence of oxygen, before its consumption, avoiding the drawbacks of storage in drums yet retaining instead the advantages thereof.

In other words, the present apparatus allows a sort of packaging in drums of the sparkling beverage, even when obtained from several liquid ingredients, directly for retail sale, that is to say for example where the beverage is consumed.

A further advantage of the present invention lies in the possibility of injecting the liquid in a rain-like fashion in the container, with wetting, and consequent washing, of the internal surface of the same container not involved by the head of liquid contained therein.

This washing is of a certain importance not only in the case of sanitising of the present apparatus, for example with solvents during cleaning operations, but also during actual use of the present apparatus.

In the case of sanitising, in fact, it is possible to use the same displacement pump to aspirate, for example, a sanitising liquid and convey it in the container wherein the rain-like or spray injection, with wetting of the internal surface of the same container, allows complete sanitisation to be obtained of the present apparatus, that is to say of the pump, connection ducts and the entire internal surface of the container.

What is described above is particularly advantageous in the case of a closed container made in one-piece, that is to say monobloc, with a cylindro-conical shape, whose interior cannot be reached in order to perform manual sanitisation operations.

In this case, advantageously, the present apparatus provides for the abovementioned detection means to be means external to the container, for example the abovementioned balance device, reducing the number of the components of the apparatus which require periodical sanitisation due to the contact with the liquid ingredients.

As regards the actual use of the present apparatus, it should be noted that the rain-like fashion injection of the liquid ingredient or of the mixture of liquid ingredients substantially from above in the container, with wetting, internally to the container, also of its surface portion which is external to the head of liquid, it has both the advantage of allowing greater exposure of the ingredients to the gasification gas, hence greater solubilisation of the gas in the liquid, and an almost constant or in any case periodical washing effect by means of the same beverage, of this surface portion external to the liquid head which avoids, as the level of the liquid head changes, sedimentation of residues of product on the wall of the container, the formation of moulds or the occurrence of fermentation phenomena of the same beverage.

The abovementioned advantage is even more important in the case of a container with a cylindro-conical shape devoid of sharp internal corners, which also allows more effective discharge or tapping of the beverage.

The above is particularly advantageous in the case of particularly thick and creamy or in any case sticky beverages, such as juices and squashes of fruit and vegetables, beer and similar beverages which have a greater possibility of stagnating on the internal surface of the container.

A person skilled in the art can make numerous modifications to the present invention, in its embodiments illustrated and described, in order to satisfy contingent and specific requirements, all of which fall within the scope of the invention, as defined in the following claims.

1. An apparatus for the production of a sparkling beverage comprising:
a container for containing said sparkling beverage having inlet and outlet openings respectively;
detection means of the level or of the weight of said sparkling beverage contained in said container;
a displacement pump located upstream of said container for feeding a given liquid ingredient or mixture of liquid ingredients therein, means apt to permit the inflation of at least one given food-grade gas or mixture of food-grade gases in said container;
at least one suction duct in communication with said displacement pump; a delivery duct extending between said displacement pump and said container; and
injection means for the injection of said liquid ingredient or mixture of liquid ingredients in said container, wherein said injection means are suitable for the injection, substantially in a rain-like or spray fashion, of said liquid ingredient or mixture of liquid ingredients in said container, in such a manner so as to wet, inside said container, substantially the entire portion of the internal surface of said container external with respect to a liquid head container therein.

2-3. (canceled)

4. The apparatus according to claim 1, wherein said container is a pressurized closed container having a cylindro-conical shape, internally essentially devoid of sharp corners.

5. The apparatus according to claim 1, comprising at least a first and a second suction duct for at least a first and a second liquid ingredient respectively, each having pre-set dimensions dependent on the proportion of said at least a first and a second liquid ingredient in said sparkling beverage.

6. The apparatus according to claim 5, wherein said at least a first and a second suction duct converge into a collecting pipe entering said displacement pump.

7. The apparatus according to claim 1, wherein said detection means of the level or of the weight of said sparkling beverage consist of a device internal to said container.

8. The apparatus according to claim 7, wherein said internal device is a suspension device, a float, a balance, a sensor or a probe.

9. The apparatus according to claim 1, wherein said detection means of the level or of the weight of said sparkling beverage consist of a device external to said container.

10. The apparatus according to claim 9, wherein said external device is a weight-detecting device, a balance, a sensor or a probe.

11. The apparatus according to claim 1, wherein said detection means are suitable for triggering the activation of said displacement pump.

12. The apparatus according to claim 1, wherein said means apt to permit the inflation in said container of at least one given-food grade gas or mixture of gases comprise at least one inlet opening in said container and at least one inflation duct connected to said at least one inlet opening.

13. The apparatus according to claim 1, wherein said means apt to permit the inflation in said container of at least one given food-grade gas or mixture of gases comprise at least one inlet opening in said delivery duct and an inflation duct connected to said inlet opening.

14. The apparatus according to claim 1, further comprising at least one electrovalve or a pressure reducer active on said at least one suction duct.

15. The apparatus according to claim 5, further comprising at least one electronic card or a PLC for the opening/closing control of said at least one suction duct.

16. A process for producing a sparkling beverage including at least a first and a second liquid ingredient comprising the steps of:
drawing from respective sources given relative amounts of said at least a first and a second liquid ingredient;
mixing, in continuous, in a common chamber, said at least a first and a second liquid ingredient, thus continuously obtaining a mixture of liquid ingredients;
conveying, in continuous, said mixture of liquid ingredients in a closed container at a pressure comprised between 0.5 and 10 bar, said pressure being exerted by at least one food-grade gas or by a mixture of food-grade gases inflated in said container, thus obtaining a pre-set liquid head of said sparkling beverage,
wherein said mixture is injected substantially in a rain-like or spray fashion in said pressurized container, so as to cause, inside said container, the wetting of substantially the entire portion of the internal surface of said container external with respect to said liquid head, and
wherein said given relative amounts are sucked up by means of the same displacement pump.

17. The process according to claim 16, wherein the aforesaid steps are repeated any time said liquid head in said container reaches a pre-set lower value.

18-19. (canceled)

20. The process according to claim 16, wherein said given relative amounts are drawn in the same time period.

21. (canceled)

22. The process according to claim 16, wherein said at least one food-grade gas is carbon dioxide and said first and second liquid ingredients consist of a high alcoholic content beer and water, respectively.

23. The process according to claim 16, wherein said mixture is upwardly injected in said pressurized container.
